(19) United States
(12) Patent Application Publication
(10) Pub. No.: US 2018/0184047 A1
(43) Pub. Date: Jun. 28, 2018

(54) VIDEO CONFERENCING CONTROL SYSTEMS

(71) Applicant: CYVIZ AS, Sandnes (NO)

(72) Inventors: Eirik SIMONSEN, Sandnes (NO); Fredrik NORUM, Sandnes (NO)

(21) Appl. No.: 15/737,623

(22) PCT Filed: Jun. 17, 2016
(86) PCT No.: PCT/GB2016/051826

§ 371 Date: Dec. 18, 2017

(30) Foreign Application Priority Data
Jun. 17, 2015 (GB) 1510672.7

(51) Int. Cl. H04N 7/15; H04L 29/06

(52) U.S. Cl. CPC H04N 7/152; G06F 3/0488; H04L 65/4038

(57) ABSTRACT

A video conferencing control system for controlling the transmission of media streams between endpoints (103, 116.1, 116.2, 116.3). The system comprises: a plurality of video conferencing endpoints; a video conferencing bridge (110) arranged to provide a virtual meeting room (114.1, 114.2, 144.3) that operates to directly connect to each of the endpoints in a given video conferencing session for the exchange of media streams; a controller (105) connected to a first endpoint (103) of the plurality of video conferencing endpoints for the management of incoming and outgoing media streams; and a user interface (107) connected to the controller. The controller is further connected to the video conferencing bridge and is configured to control operation of the virtual meeting room using an Application Programming Interface.

### CROSS-REFERENCE TO RELATED APPLICATIONS

This application is a U.S. National Stage entry under 35 U.S.C. §371 of International Application No. PCT/GB2016/051826, filed on Jun. 17, 2016, which claims the benefit of and priority to GB Patent Application No. 1510672.7, filed on Jun. 17, 2015, the entire contents of each of which are hereby incorporated by reference herein in their entireties.

### TECHNICAL FIELD

This invention relates to video conferencing control systems and associated sub-systems and methods.

### BACKGROUND

Video conferencing (VC) allows two or more endpoints to simultaneously communicate via two-way video and audio transmissions. When a VC session is initiated, a protocol is used to agree on how the two endpoints can communicate. Protocols commonly used in multimedia communication sessions include Session Initiation Protocol (SIP) and H.323—a protocol recommended by the ITU Telecommunication Standardization Sector (ITU-T) to provide audio-visual communication sessions on any packet network. The H.323 standard addresses call signalling and control, multimedia transport and control, and bandwidth control for point-to-point and multi-point conferences. Such protocols typically cover aspects such as encoding, resolution, remote camera control, sharing of content, etc. Over the years, the VC industry has established a degree of standardisation both on protocol and content. SIP is currently the norm for signalling.

In one approach, a standards-based H.323 technique, known as “multi-site” or “decentralized multi-point”, allows each endpoint in a multi-point call to exchange video and audio directly with multiple other endpoints without needing a central manager. This means that interoperability issues (e.g. endpoint model, manufacturer, age, etc.) must be handled by each endpoint. However, if there is a need to include more than three endpoints in a given VC session then a central manager or “bridge” is required.

EP 0969687 (AT&T Corp.) describes a basic system for managing an internet protocol multicast session between a plurality of endpoints using a session manager. These days, simultaneous video conferencing between three or more endpoints is made possible by a Multipoint Control Unit (MCU), which may take the form of a specialised conference management server known as a bridge. A video conferencing bridge can interconnect VC calls from several endpoints by providing a “Virtual Meeting Room” (VMR). Instead of calling other endpoints, the participating endpoints each call a specific VMR (or the VMR can also call the endpoints which are going to participate). In a VMR all participants will be visible and there are ways for the VMR to change the presentation, including voice-activated selection of the speaker. WO 2014/095499 (Pexip AS) describes a method for managing media streams in multi-party video conference by determining the loudest audio stream received.

An ongoing issue for video conferencing users is that not all systems can readily interconnect, for example ISDN and IP systems require a gateway. Popular web-based or software solutions may not easily connect to legacy hardware systems. Some systems use different standards which can require additional configuration when connecting to dissimilar systems. It has been a challenge for bridge manufacturers to provide interoperability between different video conferencing endpoints. In particular, Microsoft Lync is not interoperable with current VC industry standards, specifically using Binary Floor Control Protocol (BFCP), H.239 and its proprietary Remote Desktop Protocol (RDP) for video encoding and sharing. Video conferencing bridges are now available that can convert incompatible formats in real time. For example, Pexip AS offers a software-based conference bridge solution that enables legacy video conferencing systems to connect to Microsoft Lync, web browsers, tablets and smartphones with a degree of interoperability. Such bridges are often defined as “endpoint agnostic bridges”.

However, there remain some disadvantages in using a bridge to fix the challenge of interoperability. Endpoint users may want to initiate a multi-party video conference without setting up a bridge in advance. The bridge solution requires the participants of a video conference to call the same VMR. The VMR is a virtual extension of a physical meeting room, requiring the participants to meet in the VMR before the video conference can take place. This requires the participants to agree, in advance, where and when to meet e.g. by sending an invitation to join the VMR. If the VMR is a shared resource then it needs to be booked. And just like holding a physical meeting behind closed doors, entry to the VMR must be protected e.g. using a PIN. This protection is diluted if the same PIN is used over time, but the alternative of generating a unique PIN for each meeting makes it even harder for parties to join on an ad hoc basis. This means that the VC bridge solution is rigid to use and expensive to support. VC meetings must be planned in advance as endpoint users can not call someone on an ad hoc basis and expect interoperability. Large organisations typically fix this problem by establishing support teams which help users to set up and participate in calls. This results in a high cost for human resources.

Even those products that offer a “personal VMR”, by way of a generic bridge app on a personal mobile device, require the user to log into the bridge, locate the VMR, and call all participants—including the endpoint device in the room the user is in, which will result in an incoming call which must be answered on the device. It is still the bridge that separately controls the connection of each endpoint to the VMR.

There remains a need for systems that can provide ad hoc video conference meetings with interoperability and multiple participants. The present invention seeks to provide an improved approach to video conferencing.

### BRIEF SUMMARY

According to an aspect of the invention there is provided a video conferencing control system for controlling the transmission of media streams between endpoints, the system comprising:
a plurality of video conferencing endpoints;
a video conferencing bridge arranged to provide a virtual meeting room that operates to directly connect to each of the endpoints in a given video conferencing session for the exchange of media streams;
a controller connected to a first endpoint of the plurality of video conferencing endpoints for the management of incoming and outgoing media streams; and
a user interface connected to the controller;
wherein the controller is further connected to the video conferencing bridge and configured to control operation of the virtual meeting room using an Application Programming Interface (API).

According to another aspect of the invention there is provided a video conferencing management sub-system for use in a video conferencing control system, the sub-system comprising:
a video conferencing bridge arranged to provide a virtual meeting room that operates to directly connect to each of a plurality of video conferencing endpoints in a given video conferencing session for the exchange of media streams; and
a controller that is connectable to a user interface and to a first endpoint in the plurality of video conferencing endpoints for the management of incoming and outgoing media streams;
wherein the controller is connected to the video conferencing bridge and configured to control operation of the virtual meeting room using an Application Programming Interface (API).

According to another aspect of the invention there is provided a method of transmitting media streams between a plurality of video conferencing endpoints in a video conferencing control system, the method comprising:
connecting each of the plurality of endpoints to a virtual meeting room provided by a video conferencing bridge;
operating the video conferencing bridge to provide for the exchange of media streams between the endpoints in a given video conferencing session;
connecting a controller to a first endpoint of the plurality of video conferencing endpoints for the management of incoming and outgoing media streams;
connecting the controller to a user interface; and
connecting the controller to the video conferencing bridge and the controller using an Application Programming Interface (API) to control operation of the virtual meeting room.

The invention extends to computer software, and to a carrier bearing the same, which, when run on a controller, causes it to:
connect to a first endpoint in a plurality of video conferencing endpoints in order to manage incoming and outgoing media streams;
connect to a user interface;
connect to a video conferencing bridge arranged to provide a virtual meeting room that operates to directly connect to each of the plurality of video conferencing endpoints in a given video conferencing session for the exchange of media streams; and
control operation of the virtual meeting room using an Application Programming Interface (API).

Thus it will be appreciated that, in accordance with the invention, the API links the virtual meeting room to the controller for the first endpoint, so that the virtual meeting room becomes a virtual endpoint for a given video conferencing session rather than a centralised meeting room as in previous systems. This allows the first endpoint to act as a host for the video conference with the controller, e.g. a local controller in a meeting room, capable of initiating both transmission of an outgoing media stream to another one of the endpoints and transmission of an incoming media stream from another one of the endpoints. The video conferencing bridge becomes a passive switch for the transmission of media streams between endpoints with operation of the virtual meeting room being controlled externally of the bridge by the controller. From a user perspective, the system becomes much more transparent and a video conference can be set up easily from the first endpoint with multiple participants added on an ad hoc basis. Interoperability is handled by the bridge regardless of whether all participants of a given video conferencing session are using the same type of endpoint or not. As will be described below with reference to various embodiments of the invention, the controller can then orchestrate control over various aspects of the virtual meeting room such as initiating calls, terminating calls, initiating content sharing etc.

The controller is configured to manage incoming and outgoing media streams for the first endpoint. Preferably the controller is configured to control operation of the virtual meeting room in response to an input at the user interface, for example an operator instruction input at the user interface. When a user of the first endpoint wishes to make an outgoing call, i.e. to initiate or join a given video conferencing session between multiple participants, the controller creates a connection between the first endpoint and the virtual meeting room. Thus in a set of embodiments the controller is configured to connect the first endpoint to the virtual meeting room.

The first endpoint may join the virtual meeting room as a host. Previously, another participant would then be invited to join the virtual meeting room as well. This requires the other participant to receive the invitation and actively join the virtual meeting room, entering any required PIN. The other participant's endpoint must be provided with the address of the virtual meeting room. According to embodiments of the present invention, the controller uses the API to connect the virtual meeting room to another one of the endpoints, e.g. the controller tells the virtual meeting room to call the endpoint of the other participant. This removes the need for the bridge to invite the other participant to join the video conference and eliminates the associated latency. Moreover this enables ad hoc calls to different participants with interoperability provided by the bridge. The user of the first endpoint can initiate an unlimited number of connections to the virtual meeting room.

It will be understood that the actions described above may be carried out in any order. For example, the controller may use the API to connect the virtual meeting room to another one of the endpoints before or after instructing the first endpoint to connect to the virtual meeting room. In some embodiments these events may occur substantially simultaneously. Preferably the controller commands the first endpoint to connect to the virtual meeting room at the same time as one or more other endpoints join the video conference, to ensure that all participants are present for the video conference right from the start.

When a user of the first endpoint receives an incoming call, i.e. another participant attempts to connect to the virtual meeting room to initiate or join a given video conferencing session, the bridge creates an event to inform the controller. Thus in a set of embodiments the bridge uses the API to inform the controller when another one of the endpoints connects (or attempts to connect) to the virtual meeting room. In such embodiments the controller is configured to instruct the user interface to display an incoming call request to a first participant at the first endpoint. For example, the user interface may display a message such as “Accept incoming call from X?”. This prompts the user to accept or deny the incoming call. Advantageously, a video conference session can be set up without any of the participants needing to enter a PIN or undergo other security screening. The virtual meeting room is instead protected by the controller and the fact that it is no longer centrally accessible but linked to the first endpoint. The user interface can provide the first participant with full control as host.

When the controller receives an instruction from the user interface to accept the incoming call request, the controller is configured to connect the first endpoint to the virtual meeting room. Alternatively, the controller could use the API to connect the virtual meeting room to the first endpoint. The first participant at the first endpoint therefore enters the virtual meeting room so that a video conference is initiated between the participants. If necessary, the controller can then use the API to connect the virtual meeting room to one or more other endpoint(s) so that the first participant is present when the other participants join the video conference.

Again, it will be understood that the actions described above may be carried out in any order. For example, the controller may instruct the first endpoint to connect to the virtual meeting room before or after the virtual meeting room is connected to the other endpoint making the video conference request. In some embodiments these events may occur substantially simultaneously. Preferably the controller commands the first endpoint to connect to the virtual meeting room at the same time as allowing one or more other endpoints to join the video conference, to ensure that all participants are present for the video conference right from the start.

When the controller receives an instruction from the user interface to decline an incoming call request, the controller is configured not to connect the first endpoint to the virtual meeting room. Optionally, the controller uses the API to disconnect the virtual meeting room from one or more other endpoint(s), e.g. to terminate the attempted video conference. The first participant at the first endpoint therefore has control over hanging up an incoming call.

Whether a given video conferencing session has been initiated by the first endpoint making an outgoing call or receiving an incoming call, a first participant at the first endpoint can use the controller to hang up one or more participants during a call or to terminate the video conference for all participants. In such embodiments the controller uses the API to disconnect the virtual meeting room from one or more other endpoint(s). The controller is preferably configured to act in response to an instruction from the user interface. Of course one or more of the other endpoints may also (or additionally) disconnect spontaneously from the virtual meeting room.

The bridge can use the API to inform the controller when all of the other endpoints are disconnected from the virtual meeting room. The controller is then configured to disconnect the first endpoint from the virtual meeting room, e.g. terminating a given video conferencing session.

The actions described above may be carried out any number of times, in respect of a given video conferencing session, for multiple parties. The actions may be performed simultaneously, overlappingly or consecutively, as appropriate. Even when a session is underway, additional participants may join and/or participants may hang up—either freely or under command of the controller.

It will be appreciated that embodiments of the invention use the virtual meeting room, under the control of the controller connected to the first endpoint, as the source of all calls in and out for a given video conferencing session. This novel capability enhances ad hoc multi-participant meetings. The first participant is given the power to add individual participants when needed, to hang up individual participants when needed, and to share media streams as if all participants have the same type of endpoint.

By integrating control of the virtual meeting room with the first endpoint, the video conferencing address of the first endpoint effectively becomes the address of the virtual meeting room. To ensure that the virtual meeting room is secure, the address of the first endpoint is preferably protected. For example, the first endpoint may not be allowed to make any normal calls. The first endpoint is preferably a physical endpoint in a physical meeting room, e.g. in a dedicated video conference meeting room. This means that access to the physical endpoint can be limited. The user interface may require a PIN or password to be entered before a user can input commands to the controller.

In various of the embodiments discussed above, the virtual meeting room is controlled so as to connect to one or more endpoints other than the first endpoint. This requires the bridge to be provided with an address for each endpoint which is to join the virtual meeting room for a given video conferencing session. The Applicant has recognised that it would be advantageous for this address information to be provided automatically rather than requiring each endpoint address to be individually identified by the first participant or looked up e.g. by the controller or the bridge. In a preferred set of embodiments the controller is integrated with an email and/or calendar server, such as Microsoft Exchange, so as to access participant email addresses. For organisations that use unified communications, each email address may be used as a SIP-based address for audio and video calls i.e. media transmissions. When a video conference session booking has been sent by email to a plurality of participants, preferably the controller is configured to obtain the video conference session booking from the email and/or calendar server and display a list of the participants on the user interface. A first participant may then use the interface to select those participants from the list that it is desired to call for a given video conferencing session, e.g. by checking a check box next to the name and/or email address of those participants. Such capability promotes ad hoc calling and ease for the first participant to readily initiate a video conference session with multiple other participants.

Each of the plurality of video conferencing endpoints is preferably a device configured to simultaneously receive an incoming media stream and send an outgoing media stream. Typically each endpoint is a dedicated hardware device that provides for input and output of media streams, i.e. at least audio and video, but the media streams can also include other multimedia data or content, and optionally control data for the video conference. Each endpoint may comprise at least a display screen, video camera, microphone, and speaker. In some examples, one or more of the endpoints may be provided as part of dedicated video conferencing (VC) equipment, e.g. in a physical VC meeting room. Suitable endpoint devices include, for instance, Cisco SX80 and Polycom G700. These devices are normally controlled by their own touch panel or remote control. In some examples, one or more of the endpoints may be software-based or web-based and run on a PC or mobile computing device (smartphone, tablet, etc.), e.g. Microsoft Lync or Skype.

As has been described above, a challenge arises regarding the initiation of outgoing calls with respect to the correct choice of protocol. For example, if the VMR is instructed to initiate a call with a Microsoft Lync® endpoint, the VMR must be told to use the Microsoft® Session Initiation Protocol (MS-SIP). Conversely, other types of endpoints may require the use of H.323 or Session Initiation Protocol (SIP). In preferred embodiments, the video conferencing system is arranged to apply a predetermined rule to automatically select one or more appropriate communication protocols based on an address of at least one of the plurality of endpoints. For example, if the VMR is instructed to initiate a call to alice@sfb.example.com, the system may determine using a name-based rule that the “sfb” namespace indicates that the desired endpoint uses Skype® for Business and automatically select the SIP protocol. Thus it will be appreciated that, at least in such preferred embodiments, the system may reduce or even eliminate the need for participants to know how to call different types of endpoints.

The controller is connected to a first endpoint, managing the incoming and outgoing media streams as well as controlling the virtual meeting room provided by the bridge. This is an improvement over current video conferencing systems, where one product e.g. a hardware-based or software-based bridge controls operation of the virtual meeting room and its connections, while each of the endpoints connected to the virtual meeting room must be controlled separately. Preferably the user interface that is connected to the controller is provided in the same physical room as the first endpoint, for example in a dedicated VC meeting room. This means that an operator for the controller can also be a participant in the video conferencing session, which encourages participants to initiate their own multi-party video conference meetings without using support personnel.

The controller may be physically integrated with the first endpoint, but preferably the first endpoint is a standard video conferencing endpoint (e.g. Cisco SX20) and the controller is part of a separate hardware device. Note that the controller may use another API to connect to the first endpoint. Preferably the controller is standardised and runs configurable software so that it can be connected to many different kinds of endpoint. Once the user interface is connected to the controller, the system can provide a predictable and consistent user experience.

There is preferably provided a control device comprising the controller, and optionally also the user interface. The control device may be configured to further control one or more other components of a video conferencing system, such as video cameras, display screens, microphones, room lights, etc. Preferably the control device is located in a physical meeting room. The control device may be permanently mounted in the meeting room, i.e. as a security feature. A suitable control device may run the Cyviz Easy Controller software. Such a control device not only makes video and audio calls, but also organises the content on a display wall, controls equipment such as video cameras and microphones, and adjusts the lighting in a meeting room. The user interface may be part of the control device and preferably takes the form of a touch monitor. Alternatively, or in addition, a separate web-based user interface may be provided on a mobile device, e.g. wirelessly connected to the controller. The mobile device may run an active WebClient session, for instance an iPad using Safari with a controller WebClient.

Preferably the controller is physically external to the bridge. The controller may be connected to the bridge by a wired or wireless connection. The bridge may take the form of any hardware-based or software-based entity that is configured to provide for the exchange of media streams. In other words, the bridge is configured to accept an outgoing media stream from one or more of the endpoints and retransmit the outgoing media stream as an incoming media stream to another one or more of the endpoints. Preferably the bridge is configured to transmit media streams between endpoints that use different video conferencing protocols. For example, the bridge may be configured to transmit media streams between an endpoint (e.g. the first endpoint) using standards-based SIP or H.323 and another endpoint using RDP e.g. Microsoft Lync. Suitable may bridges include, for example, Pexip Infinity or Acano coSpaces.

The management of presenting various media streams from multiple video conferencing endpoints may be carried out manually, e.g. requiring input from a user, however in at least some embodiments the video conferencing bridge is arranged to:
receive a media streaming request from a second endpoint of the plurality of video conferencing endpoints indicating that it wishes to initiate an additional media stream; and
transmit a stream notification to at least one other of the plurality of video conferencing endpoints, the stream notification comprising information regarding the additional media stream;
wherein the first endpoint is arranged to instruct the controller to initiate the presentation of the additional media stream on one or more display devices upon receiving said stream notification. It will be appreciated that in such embodiments, a new media stream originating from a particular participant is automatically presented on suitable displays which may, by way of non-limiting example only, comprise projectors, liquid crystal display (LCD) monitors, video matrices, video processors, etc. without requiring any intervention by the operator (i.e. a participant proximate to the controller). In some further embodiments, the video conferencing bridge is arranged to transmit a termination notification to at the least one other of the plurality of video conferencing endpoints, the stream notification comprising information regarding the termination of the additional media stream; wherein the first endpoint is arranged to instruct the controller to terminate the presentation of the additional media stream on one or more display devices upon receiving said termination notification.

The bridge is preferably connected to endpoints in the video conferencing system using an Internet Protocol (IP) or possibly ISDN-based network. Multiple endpoints within the same organisation may be connected to the bridge by a private network. External participants may take part in a given video conferencing session using endpoints that are connected to the bridge by the Internet. The endpoints may communicate with the bridge using standard protocols such as MS-SIP, SIP or H.323, or any other suitable video conferencing protocol.

It will be understood that the virtual meeting room (VMR) being directly connected to each of the endpoints means that each endpoint calls the address of the VMR, or the VMR calls the address of a given endpoint, to establish an Internet Protocol (IP) and/or telephony connection. The connection is described as “direct” in that media streams are transmitted without re-addressing. However, in some examples there may be provided another bridge between the VMR and an endpoint, for instance a bridge at the endpoint that translates between different protocols as necessary.

As discussed above, the API provides an event-based communication between the VMR and the controller connected to the first endpoint. The API may be embedded in the bridge or provided as a plug-in. The API may be provided as an extension of the bridge operation and business logic.

A video conferencing “call” as mentioned herein should be understood as generally referring to a media stream between two distinct endpoints, but also includes data exchanges relating to session initiation and control protocols.

Any feature described herein with reference to one embodiment, or set of embodiments, may wherever appropriate also be used in any other of the described embodiments or aspects of the invention.

### BRIEF DESCRIPTION OF THE DRAWINGS

A preferred embodiment of the present invention will now be described, by way of example only, and with reference to the accompanying drawings, in which:

FIG. 1 is a schematic diagram of the main components in a video conferencing system; and

FIG. 2 is a schematic diagram illustrating the signalling and interaction between a video conferencing bridge and a meeting room according to an embodiment of the present invention.

### DETAILED DESCRIPTION

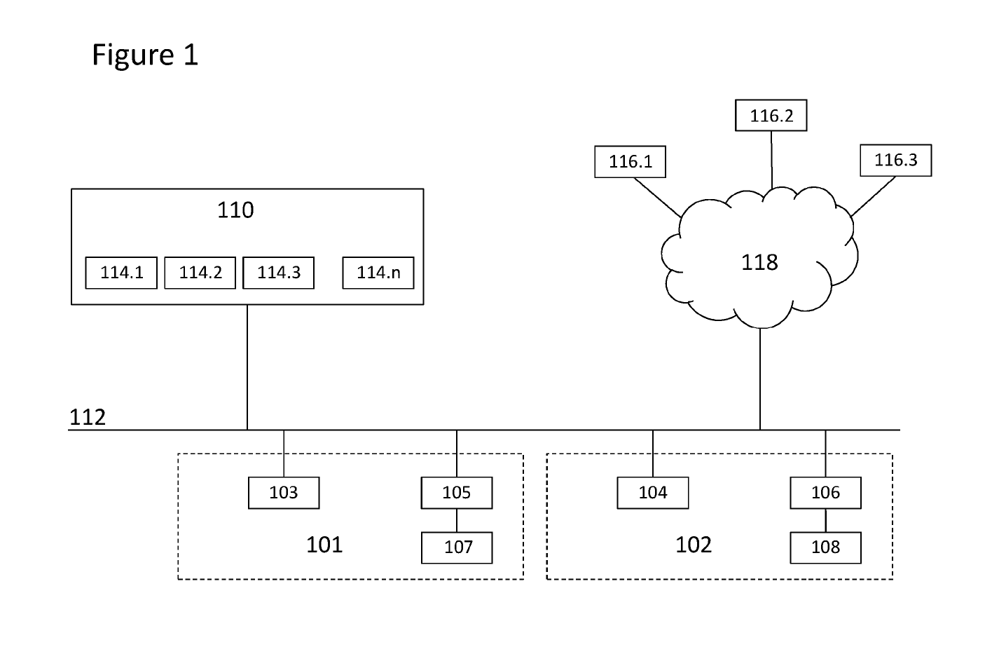

There is seen in FIG. 1 a general overview of a video conferencing system. Each physical meeting room 101, 102, etc. includes an endpoint 103, 104 which is typically a video conferencing device providing for input and output of media streams e.g. audio and video data. Also provided in each meeting room 101, 102, etc. is a controller 105, 106 which manages participation of the associated endpoint 103, 104 in a given video conferencing session, e.g. managing incoming and outgoing media streams of audio and video data. The controller 105, 106 may, for example, take the form of a device running the Cyviz Easy Controller software. A user interface 107, 108, typically in the form of a touch monitor, is connected to each controller 105, 106 to enable an operator to input commands. The controllers 105, 106 are connected to a video conferencing bridge 110 by a company network 112. The video conferencing bridge 110, for example Pexip Infinity, provides a virtual meeting room (VMR) 114.1, 114.2, 114.3, . . . 114.n for each nth video conferencing session. Each of the endpoints in a given video conferencing session is directly connected to one of the VMRs for the exchange of media streams. The bridge 110 may be capable of translating between different video conferencing protocols, thereby providing a degree of interoperability between different endpoints. One or more other participants 116.1, 116.2, 116.3, etc. may be external to the company network 112 but connected to the bridge 110 by the Internet 118. Each of the participants 116.1, 116.2, 116.3, etc. may use an endpoint that has a Cyviz Easy Controller or any other kind of video conferencing endpoint, including software-based or browser-based endpoints.

Such a video conferencing system is usually controlled by separate commands from each of the controllers 105, 106 at the endpoints 103, 104 or from each of the participants 116.1, 116.2, 116.3, etc. To set up a bridge-based video conferencing session, each endpoint calls a given VMR address, the participant enters a PIN code to enter the VMR as a host or guest, and then joins the session. However this requires each participant to receive an invitation in advance, with the VMR address provided. A company support team may be needed to help users to setup calls, book calls, prepare calls, and provide technical support during meetings.

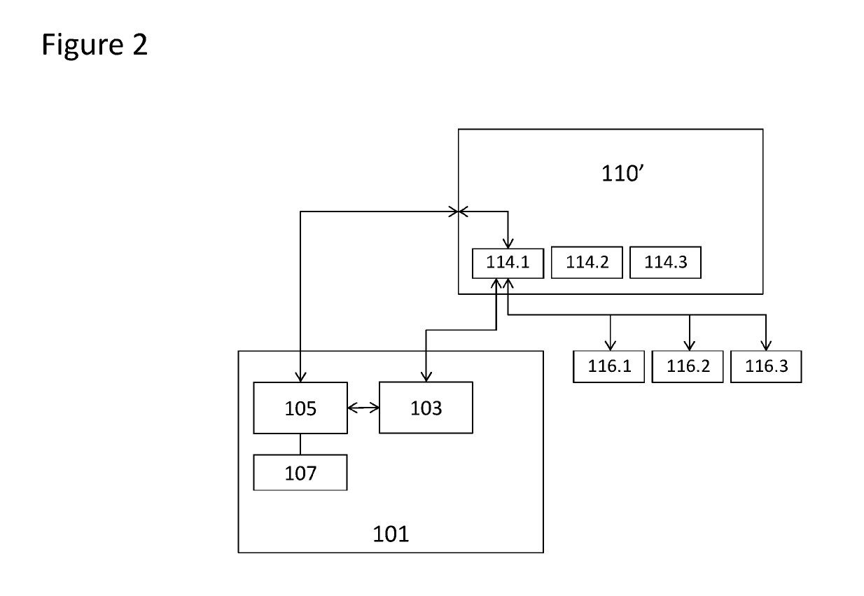

There is seen in FIG. 2 a novel video conferencing control system according to an embodiment of the invention. In the meeting room 101, the controller 105 is connected to both the user interface 107 and the physical endpoint 103. Furthermore, the controller 105 is connected to the video conferencing bridge 110′ and the bridge includes an API which allows the controller 105 to control the virtual meeting rooms (VMRs) 114.1, 114.2, 114.3, etc. There is established an event-driven, two-way communication between the controller 105 and the bridge 110′.

When a host in the meeting room 101 want to make an outgoing call, the controller 105 tells the VMR 114.1 (via the API) to make a call to the address of a given endpoint e.g. another participant 116.1, 1162, 116.3, etc. At the same time, the controller 105 tells the physical endpoint 103 to call the VMR 114.1, so that the user is a participant in the meeting when the outgoing call is successful i.e. as someone answers the call. This allows users to make ad-hoc video calls with interoperability. The bridge 110′ will by default support multiple participants, allowing the user to call an unlimited number of participants and add them to the session in the VMR 114.1 without advance invitations being required. The host can also use the controller 105 to hang up any of the participants, by using the API to disconnect a given endpoint from the VMR 114.1. If there are no participants left in a given session then the controller 105 will command the endpoint 103 to leave the VMR 114.1.

When an external participant 116.1, 1162, 116.3, etc. wants to join the VMR 114.1 for a given video conferencing session, the associated endpoint will use the address of the VMR 114.1 in an attempt to connect. As soon as the bridge 110′ detects an incoming call to a VMR 114.1 controlled by the controller 105, the controller 105 is informed of the event using the API. The controller 105 processes the event and prompts the host in the meeting room 101 to accept or deny the incoming call request. A message is shown on the touch monitor 107, such as “Incoming call from . . . Accept/Hang up?”. At the same time, the physical endpoint 103 is told to enter the VMR 114.1, so that the host is present when the other participant(s) 116.1, 1162, 116.3, etc. join the meeting. This removes the need for PIN code protection. The controller 105 becomes the access control device—using the touch monitor 107 to offer the host full control over who participates in the session.

1. A video conferencing control system for controlling the transmission of media streams between endpoints, the system comprising:
a plurality of video conferencing endpoints;
a video conferencing bridge arranged to provide a virtual meeting room that operates to directly connect to each of the endpoints in a given video conferencing session for the exchange of media streams;
a controller connected to a first endpoint of the plurality of video conferencing endpoints for the management of incoming and outgoing media streams; and
a user interface connected to the controller;
wherein the controller is further connected to the video conferencing bridge and configured to control operation of the virtual meeting room using an Application Programming Interface (API).

2. The video conferencing control system of claim 1, wherein the controller is configured to control operation of the virtual meeting room in response to an input at the user interface.

3. The video conferencing control system of claim 1, wherein the controller is configured to connect the first endpoint to the virtual meeting room.

4. The video conferencing control system of claim 3, wherein the controller uses the API to connect the virtual meeting room to another one of the endpoints.

5. The video conferencing control system of claim 1, wherein the bridge uses the API to inform the controller when another one of the endpoints connects, or attempts to connect, to the virtual meeting room.

6. The video conferencing control system of claim 5, wherein the controller is configured to instruct the user interface to display an incoming call request to a first participant at the first endpoint.

7. The video conferencing control system of claim 6, wherein, when the controller receives an instruction from the user interface to accept the incoming call request, the controller is configured to connect the first endpoint to the virtual meeting room.

8. The video conferencing control system of claim 6, wherein, when the controller receives an instruction from the user interface to decline the incoming call request, the controller is configured not to connect the first endpoint to the virtual meeting room.

9. The video conferencing control system of claim 1, wherein the controller uses the API to disconnect the virtual meeting room from one or more other endpoint(s).

10. The video conferencing control system of claim 1, wherein the controller uses the API to connect the virtual meeting room to one or more other endpoint(s).

11-23. (canceled)

24. A video conferencing management sub-system for use in a video conferencing control system, the sub-system comprising:
a video conferencing bridge arranged to provide a virtual meeting room that operates to directly connect to each of a plurality of video conferencing endpoints in a given video conferencing session for the exchange of media streams; and
a controller that is connectable to a user interface and to a first endpoint in the plurality of video conferencing endpoints for the management of incoming and outgoing media streams;
wherein the controller is connected to the video conferencing bridge and configured to control operation of the virtual meeting room using an Application Programming Interface (API).

25. A method of transmitting media streams between a plurality of video conferencing endpoints in a video conferencing control system, the method comprising:
connecting each of the plurality of endpoints to a virtual meeting room provided by a video conferencing bridge;
operating the video conferencing bridge to provide for the exchange of media streams between the endpoints in a given video conferencing session;
connecting a controller to a first endpoint of the plurality of video conferencing endpoints for the management of incoming and outgoing media streams;
connecting the controller to a user interface; and
connecting the controller to the video conferencing bridge and the controller using an Application Programming Interface (API) to control operation of the virtual meeting room.

26. The method of claim 25, further comprising:
the controller operating in response to an input at the user interface.

27. The method of claim 25, further comprising:
the controller operating to connect the first endpoint to the virtual meeting room.

28. The method of claim 27, further comprising:
the controller using the API to connect the virtual meeting room to another one of the endpoints.

29. The method of claim 25, further comprising:
the bridge using the API to inform the controller when another one of the endpoints connects, or attempts to connect, to the virtual meeting room.

30. The method of claim 29, further comprising:
the controller instructing the user interface to display an incoming call request to a first participant at the first endpoint.

31. The method of claim 30, further comprising:
the controller receiving an instruction from the user interface to accept the incoming call request and operating to connect the first endpoint to the virtual meeting room.

32. The method of claim 30, further comprising:
the controller receiving an instruction from the user interface to decline the incoming call request and operating not to connect the first endpoint to the virtual meeting room.

33. The method of claim 25, further comprising:
the controller using the API to disconnect the virtual meeting room from one or more other endpoint(s).

34-40. (canceled)
